(19) United States
(12) Patent Application Publication
(10) Pub. No.: US 2026/0103137 A1
(43) Pub. Date: Apr. 16, 2026

(54) VEHICLE TIE-DOWN ADAPTER ASSEMBLY

(71) Applicant: B & W Custom Truck Beds, Inc., Humboldt, KS (US)

(72) Inventor: Tyler Jelinek, Manhattan, KS (US)

(73) Assignee: B & W Custom Truck Beds, Inc., Humboldt, KS (US)

(21) Appl. No.: 19/355,156

(22) Filed: Oct. 10, 2025

Related U.S. Application Data
(60) Provisional application No. 63/706,360, filed on Oct. 11, 2024.

(51) Int. Cl. B60P 3/079

(52) U.S. Cl. CPC B60P 3/079

(57) ABSTRACT

A tie-down assembly including a pair of adapters, a clamp, and a base. Each adapter includes a mounting structure that is securable to a frame member of a vehicle and a clamp-engageable member that is spaced apart from the mounting structure and oriented downwardly of the frame member to which the mounting structure is securable. Each clamp-engageable member is exposed near a bottom surface of the vehicle and the clamp is adjustably engageable with the clamp-engageable members. The clamp is configured to be releasably captured by a pair of latch assemblies that are disposed at opposite ends of the base, and the latch assemblies are spaced apart such that at least a portion of the vehicle is receivable between the latch assemblies.

### CROSS REFERENCE TO RELATED APPLICATION

This application claims the benefit of U.S. Provisional Patent Application No. 63/706,360 filed October 11, 2024, the disclosure of which is hereby incorporated herein in its entirety by reference.

### BACKGROUND

Many devices are present in the art for securing a motorcycle during transport and storage. For example, flexible tie-down straps have been used for many years. Typically, such straps require attachment to a motorcycle at four locations. Common practice with the straps is to compress the suspension at one end of the motorcycle, secure a strap on either side of the motorcycle, then repeat the process at the other end of the motorcycle. The ends of the straps opposite those attached to the motorcycle must be secured to some part of the object to which the motorcycle is temporarily attached. The drawbacks to such straps are numerous, including the tendency to loosen during transport, difficulty in locating a proper securing point on the motorcycle itself, difficulties in locating proximal securing points for the ends of the straps opposite those attached to the motorcycle, and, often, undesirable compression of or stress on the motorcycle’s suspension.

Other devices exist which are firmly secured to various parts of a motorcycle, such as to the handlebars or the forks. Many devices temporarily engage either side of a tire or wheel in a track-like arrangement. All of these devices have shortcomings, including potential marring of the motorcycle, rubbing of tires and wheels, and cumbersome and space-consuming designs. Additionally, releasing the motorcycle is often quite difficult, and without assistance, the motorcycle may fall over.

### SUMMARY

Embodiments of the invention are defined by the claims below, not this summary. A high-level overview of various aspects of the invention is provided here to introduce a selection of concepts that are further described in the Detailed Description section below. This summary is not intended to be used in isolation to determine the scope of the claimed subject matter. In brief, this disclosure describes, among other things, a motorcycle tie-down apparatus that secures a motorcycle while in transit.

The motorcycle tie-down assembly comprises adapters, a clamp, and a base. The adapters include mounting structures that are securable to frame members of a motorcycle and clamp-engageable members that are oriented downwardly of the frame members and are exposed near the bottom of the motorcycle to be selectively engaged by the clamp. The clamp is adjustable for engagement with the clamp-engageable members and the clamp is removably securable to the base, which is secured to a transport vehicle. The base includes a pair of latch assemblies disposed proximate opposite ends thereof that are configured to releasably capture the clamp. The latch assemblies are spaced sufficiently such that at least a portion of the motorcycle is receivable between the latch assemblies when the latch assemblies capture the clamp and the clamp engages the clamp-engageable members to secure the motorcycle to the transport vehicle.

### DESCRIPTION OF THE DRAWINGS

Illustrative embodiments of the invention are described in detail below with reference to the attached drawing figures, and wherein:

FIG. 1 is a perspective view of adapters and a clamp of a vehicle tie-down assembly in accordance with an embodiment of the invention, viewed from above and to the right and depicted with the adapters secured to both the clamp and the frame members of a vehicle;

FIG. 2 is a perspective view of the vehicle tie-down assembly of FIG. 1, viewed from above and to the right and depicted with footrest mounting brackets secured to the adapters and the frame members of the vehicle;

FIG. 3 is a side elevational view of an adapter of FIG. 1, viewed from the right and depicted with the adapter secured to a frame member of the vehicle;

FIG. 4 is a perspective view of the adapter of FIG. 3, viewed from above and to the right;

FIG. 5 is a perspective view of an alternative embodiment of the adapters, viewed from above and to the right and depicted with the adapters secured to both the clamp and the frame members of the vehicle of FIG. 1;

FIG. 6 is a perspective view of the adapters of FIG. 5, viewed from above and to the right and depicted with footrest mounting brackets secured to the adapters, and to the frame members of the vehicle of FIG. 1;

FIG. 7 is a side elevational view of an adapter of FIG. 5, viewed from the right and depicted with the adapter secured to a frame member of the vehicle;

FIG. 8 is a perspective view of the adapter of FIG. 5, viewed from above and to the right;

FIG. 9 is a front elevational view of the clamp of FIG. 1 and a base of the vehicle tie-down assembly in accordance with an embodiment of the invention, depicted with the clamp secured to the base and with the adapters removed for clarity;

FIG. 10 is a front elevational view of the clamp of FIG. 1;

FIG. 11 is a perspective view of the clamp of FIG. 1, viewed from above and to the right;

FIG. 12 is a perspective inner side view of a mounting bracket and a latching assembly of the base of FIG. 9;

FIG. 13 is a rear elevational view of a mounting bracket and a latching assembly of the base of FIG. 9;

FIG. 14 is an outer side elevational view of a mounting bracket and a latching assembly of the base of FIG. 9, depicted with the latching assembly in a locked orientation;

FIG. 15 is an outer side elevational view of a mounting bracket and a latching assembly of the base of FIG. 9, depicted with the latching assembly in an unlocked orientation and with a pair of coil springs removed for clarity;

FIG. 16 is an outer side elevational view of a mounting bracket and a latching assembly of the base of FIG. 9, depicted with the latching assembly in an unlatched orientation and with a pair of coil springs removed for clarity;

FIG. 17 is an outer side elevational view of a mounting bracket and a latching assembly of the base of FIG. 9, depicted with the latching assembly in a released or armed orientation and with a pair of coil springs removed for clarity;

FIG. 18 is an enlarged partial perspective view of the clamp of FIG. 1 and the base of FIG. 9, depicted with the clamp secured to the base and with the adapters removed for clarity.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described.

Certain terminology will be used in the following description for convenience in reference only and will not be limited. For example, the words “upwardly,” “downwardly,” “rightwardly,” and “leftwardly” will refer to directions in the drawings to which reference is made, and the words “inwardly” and “outwardly” will refer to directions toward and away from, respectively, the geometric center of the embodiment being described and designated parts thereof. The words “front” or “forward” will generally refer to the left side of the page of the drawing to which reference is made, and the words “rear” or “rearward” will generally refer to the right side of the page of the drawing to which reference is made. The words “mounted,” “connected,” “joined,” “attached,” “secured,” or variations thereof will refer to parts, elements, or components that are both formed separately or joined together, as by welding or through a mechanical coupling, or parts, elements, or components that are integrally formed together. The terms “about” or “approximately” as used herein denote deviations from the exact value by +/- 10%, preferably by +/- 5%, and/or deviations in the form of changes that are insignificant to the function. Said terminology will include the words specifically mentioned, derivatives thereof, and words of a similar import.

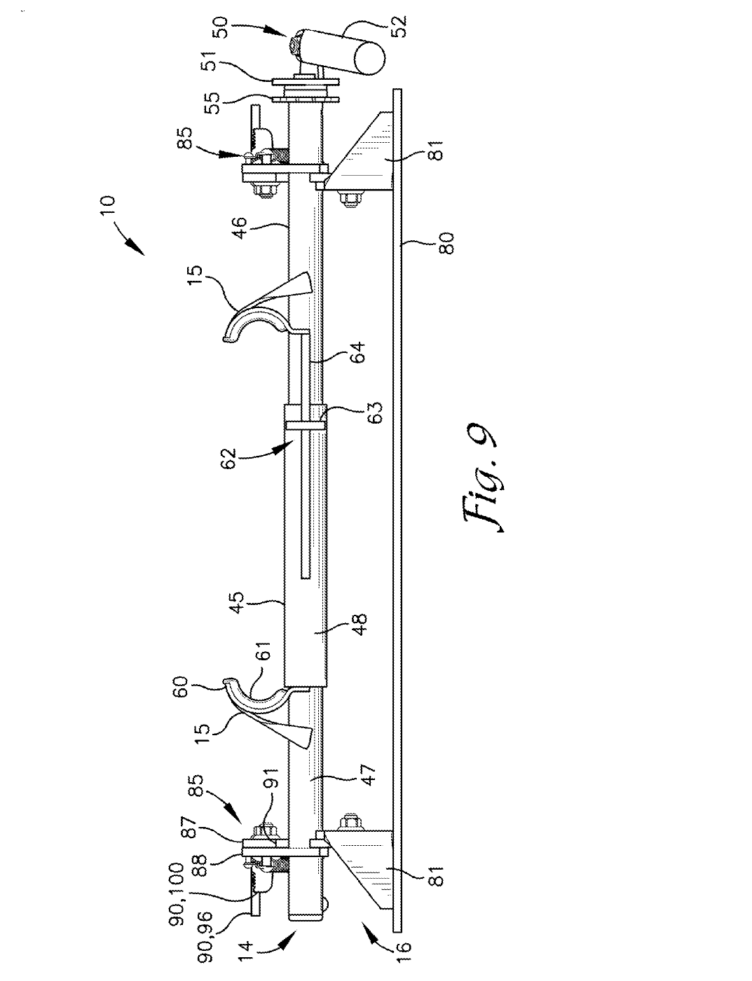

With reference now to the drawings, a vehicular tie-down assembly 10 and an adapter assembly 11 are described in accordance with an embodiment of the invention. The adapter assembly 11 comprises a first adapter 12 and a second adapter 13 that are mounted to the frame of a motorcycle, with the adapter assembly 11 configured to enable use of the tie-down assembly 10 with various types of motorcycles. The tie-down assembly 10 comprises an adjustable clamp 14 equipped with clamp members or clamp arms 15 that releasably engage and clamp against the first and second adapters 12 and 13, and a base 16, an example of which is shown in FIG. 9, that can be fixedly disposed on a surface of a transport vehicle or trailer and is engageable with the clamp 14 to secure the vehicle to the transport vehicle for transport.

Embodiments of the invention are described herein with reference to a motorcycle, but it should be understood that the vehicular tie-down assembly 10 may be employed to tie down or secure other motorized vehicles such as all-terrain vehicles, mopeds, dirt bikes, or similar street-legal and off-road vehicles having two, three, or four wheels. Preferably, the vehicle to be secured includes a pair of frame members that extend longitudinally along the length of the vehicle near a bottom edge or surface thereof and are exposed for mounting the first and second adapters 12 and 13 thereto. But it is understood that the first and second adapters 12 and 13 can be mounted to other features of the vehicle without departing from the scope of embodiments of the invention described herein.

The embodiments of the adapter assembly 11 disclosed herein are particularly well adapted for use with Indian® brand motorcycles, with the first and second adapters 12 and 13 configured to be mounted to frame members thereof and engageable by clamp members or arms 15 of a clamp 14 and a base 16 of the type disclosed in U.S. Patent Nos. 7,347,653 and 9,623,784. The first and second adapters 12 and 13 mirror each other and are generally opposingly oriented, with each adapter 12, 13 secured to a respective first and second frame member 17 and 18 extending along opposite sides of the motorcycle. The first adapter 12, which may also be referred to as the right adapter 12, is secured to a frame member 17 extending along the right side of the motorcycle and is oriented between the frame member 17 and a bracket 19a for mounting a right-side footrest to the frame member 17. The second adapter 13, which may also be referred to as the left adapter 13, is similarly secured to a frame member 18 extending along the left side of the motorcycle and is oriented between the frame member 18 and a bracket 19b for mounting a left-side footrest to the frame member 18.

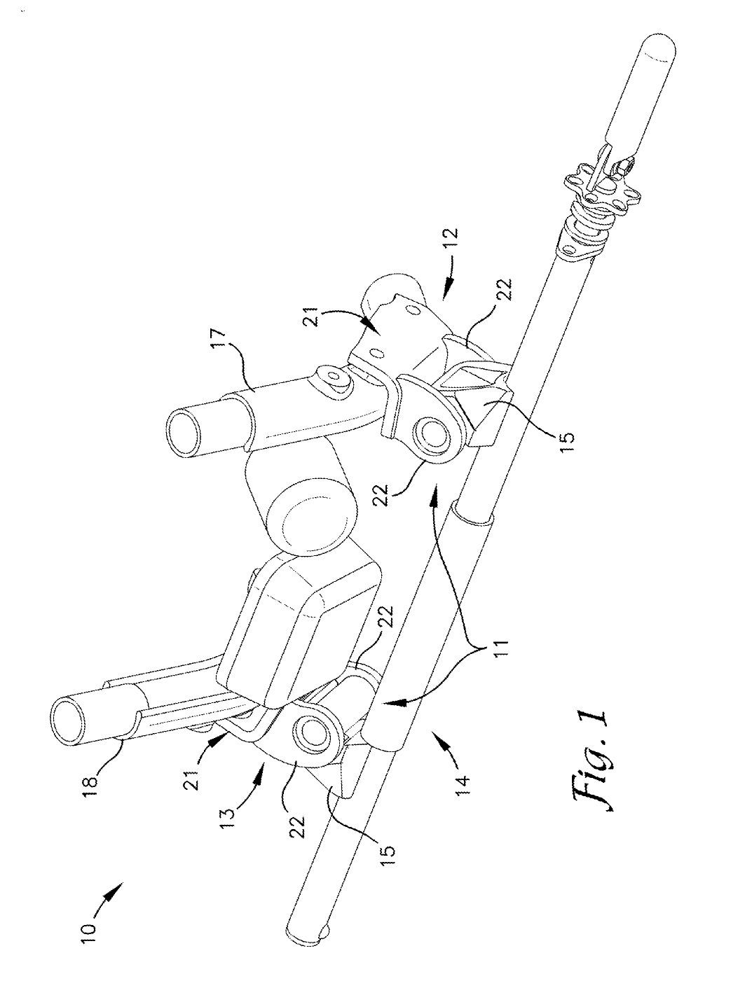

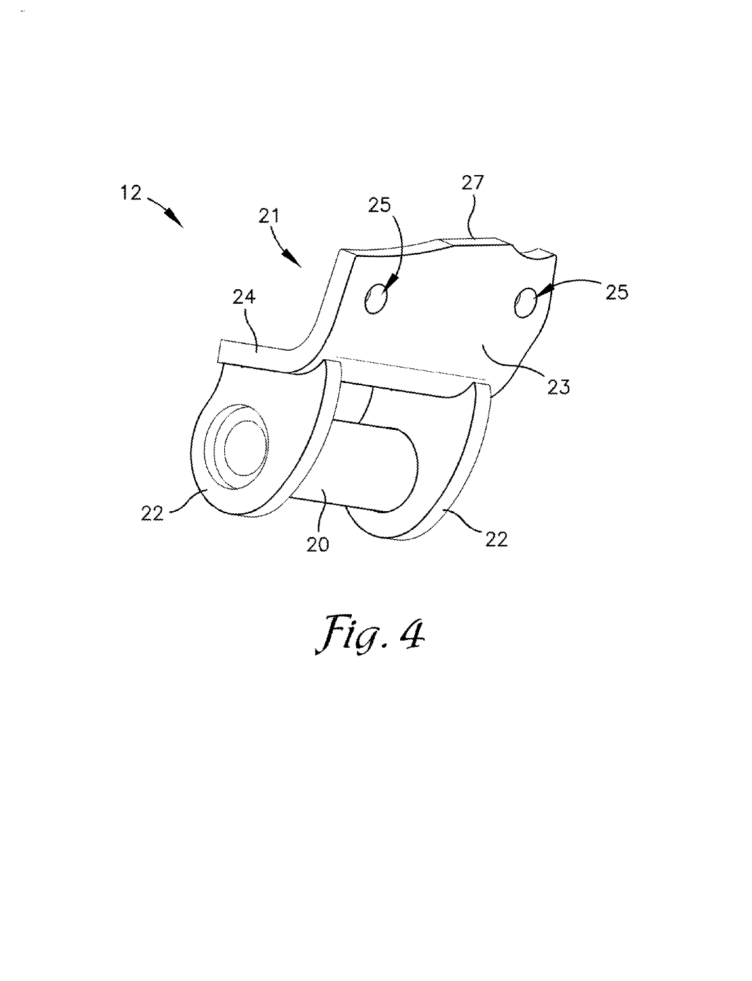

First and second adapters 12 and 13 each comprise a clamp-engageable structure or member 20 connected to a mounting bracket 21. In the embodiment shown in FIGS. 1-4, the clamp-engageable member 20 comprises a tube or cylindrical bar 20 supported in spaced relation from the mounting bracket 21 by a pair of spacer plates or mounting flanges 22. The clamp-engageable member 20 is shaped to present a surface that matingly conforms to and is engageable with the shape of the clamp members or arms 15. In the embodiment shown, the clamp members 15 have respective semi-cylindrical curved inner surfaces, which are substantially convex, and the respective cylindrical clamp-engageable members 20 present mating curved outer surfaces, which are substantially concave.

The mounting bracket 21, of the embodiment shown, may be described as approximately L-shaped having a first portion or first leg 23 and a second portion or second leg 24. The second leg 24 extends approximately perpendicular to the first leg 23. The first leg 23 is shaped and configured to be positioned against and extend along an outer side of a respective frame member 17 or 18 in a plane parallel to a longitudinal axis of a frame member 17 or 18 with the second leg 24 extending beneath the frame member 17 or 18 in a plane approximately transverse to the plane occupied by the first leg 23. The first leg 23 of mounting bracket 21 is secured to the respective frame member 17 or 18 proximate a bend thereof with a pair of bores 25 formed in the first leg 23 in spaced apart relationship in a spacing corresponding to the spacing between bolt holes (not shown) formed in bosses 26a and 26b formed on the respective frame member 17 or 18. An upper edge 27 of the first leg 23 of bracket 21 may be contoured or shaped to match the bend in the frame member 17 or 18 to which the respective mounting bracket 21 is secured or to include recesses or the like to avoid interference with structure or motorcycle components extending adjacent the frame member 17 or 18 to allow securement of the mounting bracket 21 to the frame member 17 or 18. Each bore 25 is axially alignable with a corresponding bore formed in a respective boss 26a or 26b or other mounting feature formed on the frame member 17 or 18 for mounting a vehicle component, such as the footrest brackets 19a, 19b of the embodiment shown, to each of the frame members 17 and 18. Screws or other fasteners (not shown) provided for connecting the respective footrest brackets 19a and 19b to the respective frame members 17 and 18 are extendable through the mounting features of the footrest brackets 19a, 19b (or other vehicle components), through the bores 25 formed in the first leg 23 of the mounting bracket and through the bosses 26a or 26b of the respective frame members 17 and 18 for securing the first legs 23 of the respective mounting brackets 21 between the respective footrest mounting features 19a, 19b and the respective frame members 17, 18.

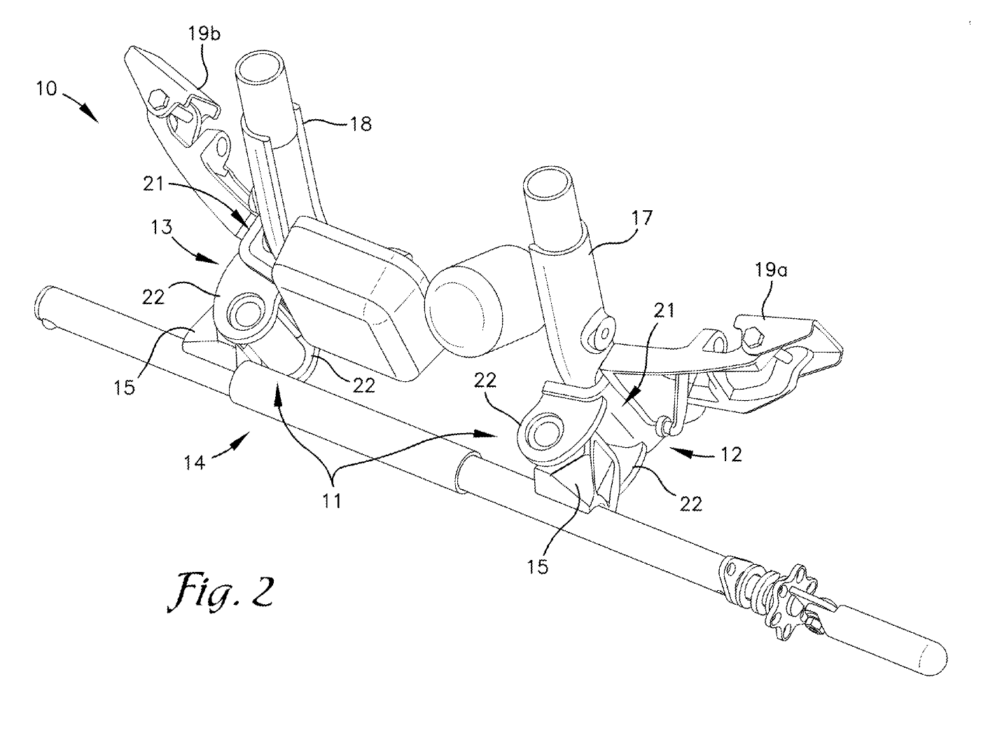

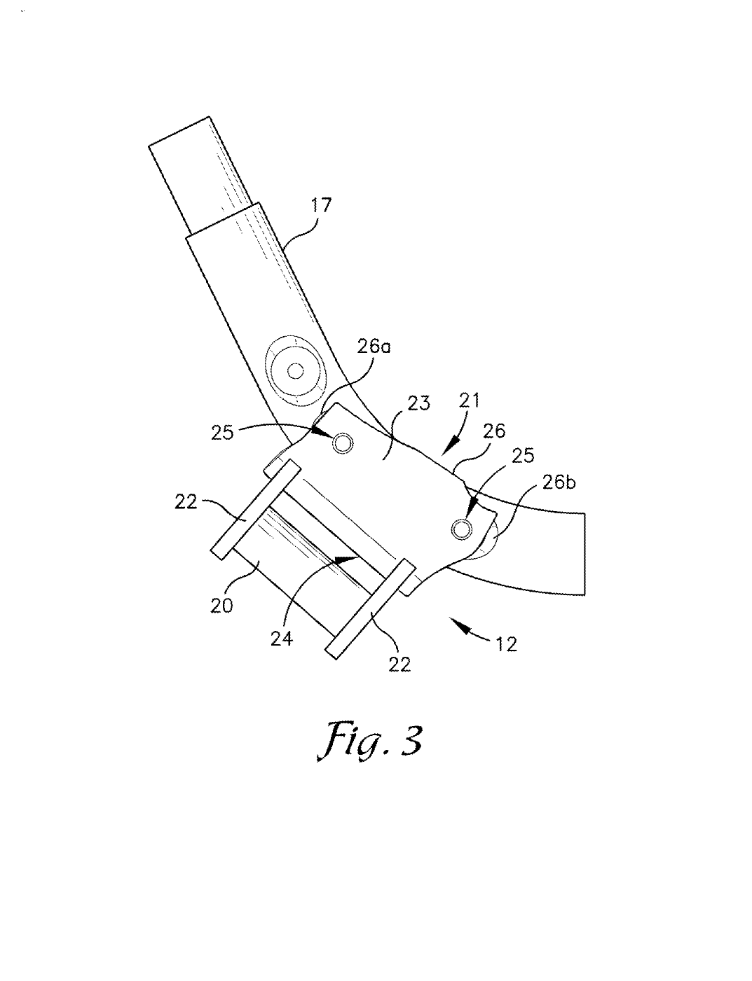

Each mounting flange 22 projects downwardly and forwardly from an opposite end of the lower or second leg 24 and may curve slightly inwardly such that each mounting flange 22 may be described as a lobe. The clamp-engageable member 20, which is a tubular bar 20 in the embodiment shown, extends longitudinally between the mounting flanges 22 such that the bar 20 is oriented downwardly and forwardly of the frame member as shown in FIGS. 2 and 3. It is foreseeable that the mounting flanges 22 could be substantially rectangular, substantially elliptical, or of other like shapes. The bar 20 is spaced apart from the second leg 24 sufficient for a portion of a corresponding clamp arm 15 to fit between the bar 20 and the second leg 24 and the bar 20 provides a clampable surface sufficient for the bar 20 to be received within a corresponding clamp arm 15 as described more fully below. The bar 20 is a hollow, tubular structure in the embodiment shown and described herein, but it is understood that the bar may alternatively be a solid cylindrical structure or a semi-cylindrical structure. It is also foreseen that the mating surfaces of the bar 20 and the clamp member 15 may be formed in other mating shapes.

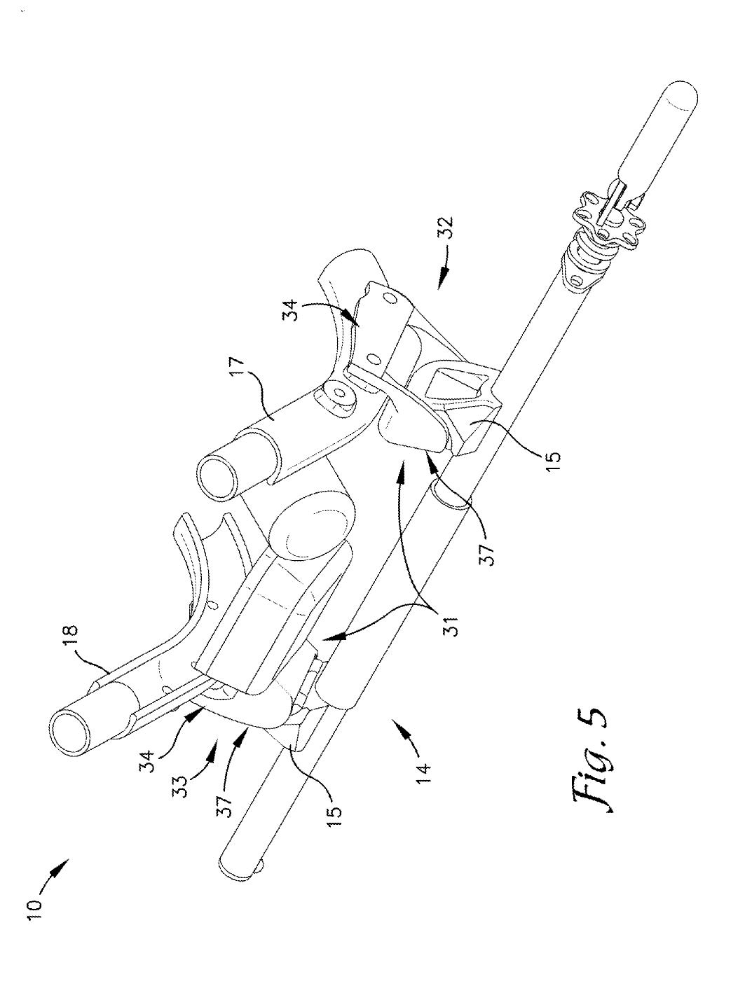

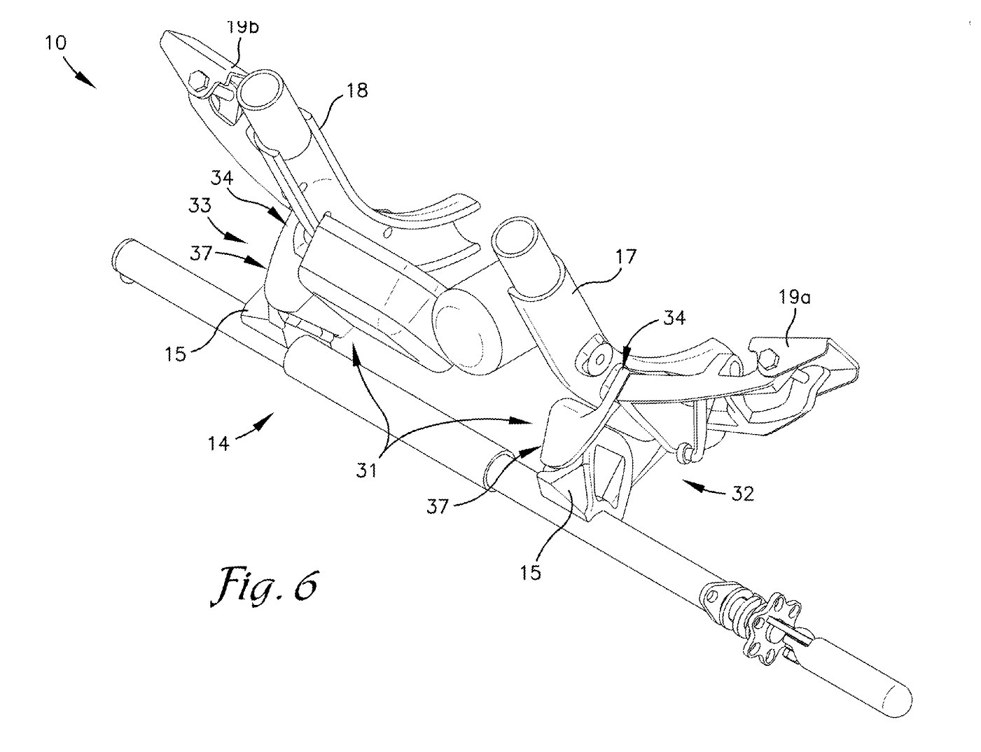

FIGS. 5-8 depict an alternative embodiment of the adapter assembly, which is denominated herein as adapter assembly 31 and comprises first and second adapters 32 and 33, which may be referred to as right and left adapters 32 and 33, respectively, corresponding to the side of the motorcycle along which the frame member 17 or 18 that the adapter 32 or 33 is secured to extends. The first and second adapters 32 and 33 each comprise a clamp-engageable structure 41 integrally formed with and connected to a frame mounting structure 34 in the nature of an integral mounting bracket 34. The mounting structure 34 of the embodiment shown is generally L-shaped having a first portion or first leg 35 extending approximately perpendicular to a second portion or second leg 36. The first leg 35 is adapted to be positioned to extend against a side of a frame member 17 or 18 in a plane parallel to a longitudinal axis of the frame member 17 or 18, with the second leg 36 extending generally under the frame member 17 or 18. The first leg 35 of the mounting structure 34 may include holes or threaded bores 37, similar to the bores 25 of the mounting bracket 21, for receiving fasteners for securing the first leg 35 of the mounting structure 34 between the frame member 17 or 18 and the respective footrest mounting bracket 19a or 19b.

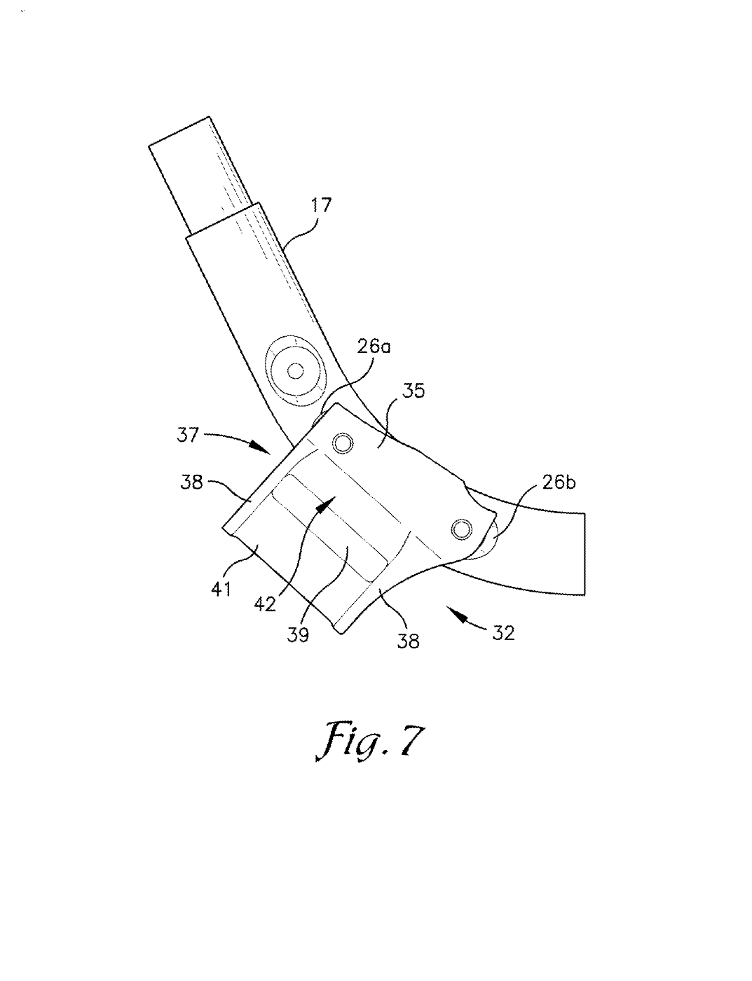

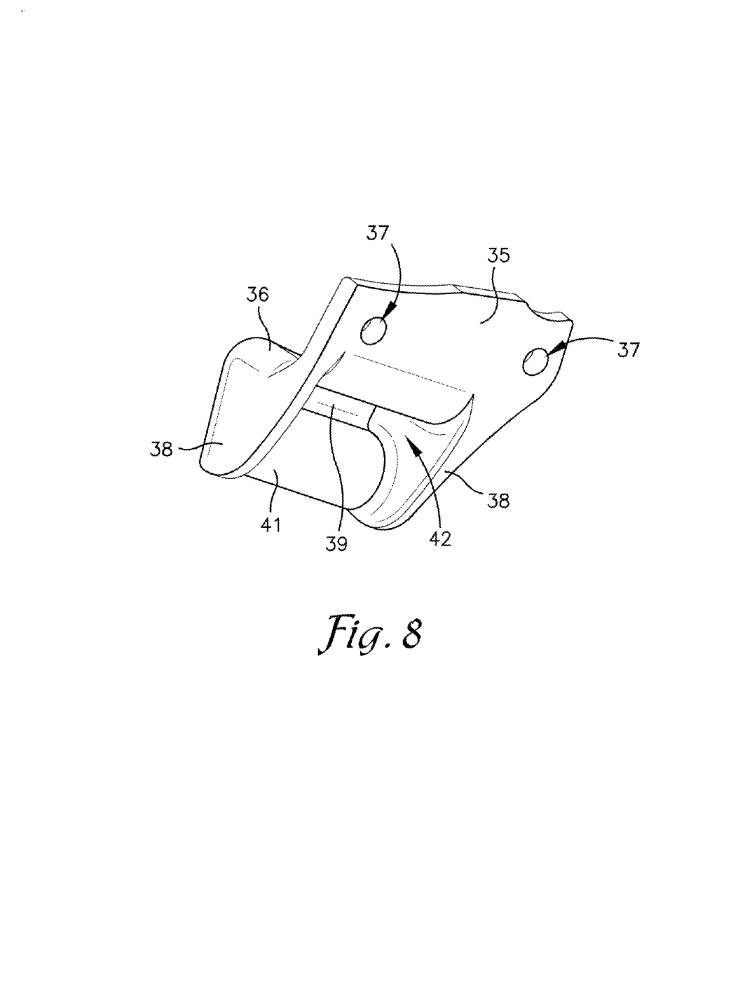

The clamp-engageable structure 41 is formed integral with and generally extends below the second portion 36 of mounting structure 34. The clamp-engageable structure 41 is formed as a semi-cylindrical rib or protuberance having a semi-cylindrical surface oriented to face outward relative to the frame member 17 or 18 of the motorcycle to which it is attached by the mounting structure 34. A pair of end portions or end walls 38 and a side portion connect the semi-cylindrical clamp-engageable structure 41 to the second leg 36, with the end walls 38 extending downwardly and forwardly from opposite ends of the second leg 36 and the side portion 39 extending downwardly and outwardly from the inner edge of the second leg 36, such that the clamp-engageable structure 41 extends in spaced relation to the second leg 36, and the clamp-engageable structure 41 and the second leg 36 cooperate to form a recess or pocket 42. As shown in FIGS. 7 and 8, a pocket 42 is formed between the second leg 36, the clamp-engageable structure 41, and the end portions 38 and side portion 39 of each adapter 32, 33. The clamp-engageable structure 41 extends between the end portions 38 and may be described as protruding into the pocket 42, with the clamp-engageable structure 41 oriented on the lower half of the side portion 39 and spaced apart from the second portion 36 sufficient for a portion of a corresponding clamp arm 15 to fit between the clamp-engageable portion 41 and the second leg 36 of the mounting structure 34. The semi-cylindrical clamp-engageable structure 41 includes an arc length sufficient for the clamp-engageable structure 41 to be received within a corresponding clamp arm 15 as described more fully below.

In operation, the footrest mounting brackets 19a and 19b are removed from the frame members 17 and 18 of the motorcycle, and the right and left adapters 12 and 13 are advanced toward the respective frame members 17 and 18 until the bores 25 formed in the right and left adapters 12 and 13 are axially aligned with the bosses 26a and 26b or other mounting features formed in the frame members 17 and 18. With the right and left adapters 12 and 13 so oriented, the footrest mounting brackets 19a and 19b are advanced toward the right and left adapters 12 and 13, respectively, until the mounting features formed in the footrest mounting brackets 19a and 19b are axially aligned with the bores 25 and the mounting features formed in the frame members 17 and 18. Fasteners are extended through the footrest mounting brackets 19a and 19b, the bores 25 of the adapters 12 and 13, and the frame members 17 and 18, such that the right and left adapters 12 and 13 are secured to the respective frame members 17 and 18 and are oriented between the respective frame members 17 and 18 and the respective footrest mounting brackets 19a and 19b.

It is understood that references herein to the functionality and operation of first and second adapters 12 and 13 and the specific features and components thereof are generally intended to encompass the functionality and operation of first and second adapters 32 and 33 and the specific features and components thereof which have substantially equivalent purposes, as would be apparent to those skilled in the art. For example, references herein to the clamp-engageable member or bar 20 of the first or second adapter 12 or 13 are generally intended to encompass references to the clamp-engageable structure 41 of the first or second adapter 32 and 33.

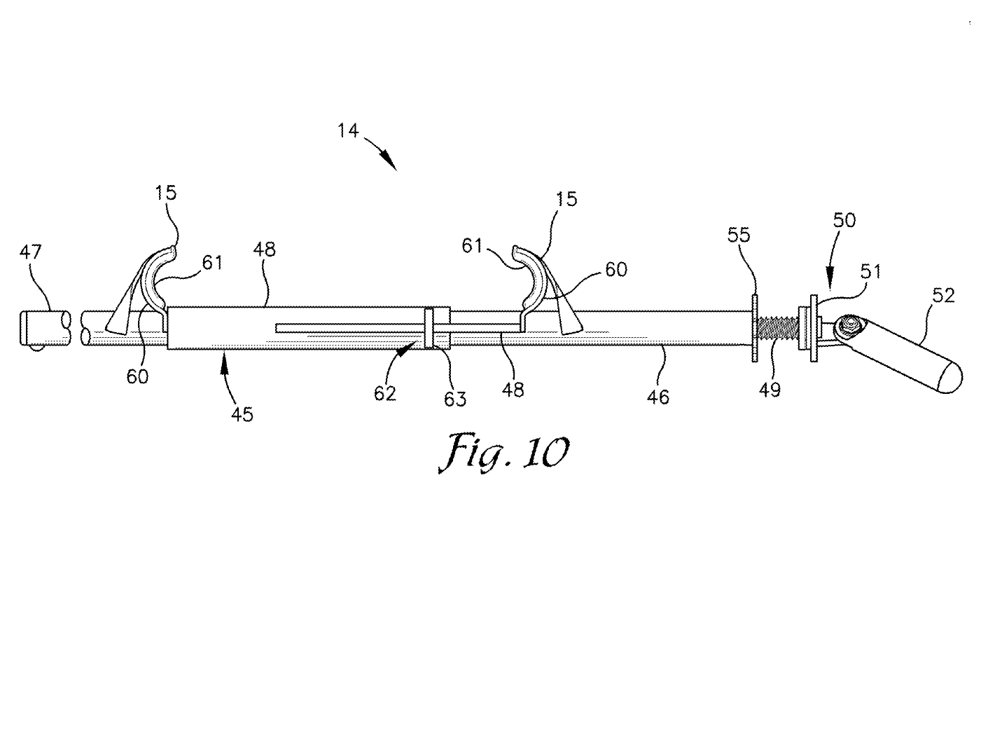

With additional reference now to FIGS. 9-11, the adjustable clamp 14 comprises a receiving tube 45 and a nested tube 46. The receiving tube 45 includes an end portion 47 and a receiver 48. The end portion 47 and the nested tube 46 each have a hollow interior and similar diametrical dimensions. The receiver 48 extends from one end of the end portion 47 toward the nested tube 46 and includes an inner diameter sufficient to receive the nested tube 46 therein, with the receiver 48 and the nested tube 46 moveable in slidable or telescopic relation to laterally displace the clamp arms 15 secured thereto toward and away from each other.

A threaded rod 49 is disposed coaxially within the receiving tube 45 and the nested tube 46. A threaded nut or coupling (not shown) is disposed within the receiving tube 45 at a position preferably along the length of the end portion 47 or at or near the junction between the end portion 47 and the receiver 48. One end of the threaded rod 49 threadably engages the threaded coupling and an opposite end of the threaded rod 49 fixedly and non-rotatably couples with a handle assembly 50. The nested tube 46 is thus captured between the engagement of the threaded rod 49 with the threaded coupling in the receiving tube 45 and the handle assembly 50. Rotation of the handle assembly 50 about the longitudinal axis of the threaded rod 49 operates to move the handle assembly 50 toward or away from the receiving tube 45 and thus to move the nested tube 46 further into the receiver 48 or to allow withdrawal therefrom.

The handle assembly 50 includes a first securement flange 51 that extends radially outward from the threaded rod 49 in one or more radial directions and a pivotable handle 52. As best seen in FIG. 11, one or more bores 53 are formed in the first securement flange 51 and extend parallel to the threaded rod 49. The bores 53 are configured to be selectively aligned with one or more bores 54 which are formed in a second securement flange 55 that extends radially outward from an adjacent end of the nested tube 46. Axial alignment of the bores 53 and the bores 54 enables insertion of a locking pin, padlock, strap, or the like through bores 53, 54 to prevent rotation of the handle assembly 50 relative to the nested tube 46.

The handle 52 is pivotably mounted at a distal end of the handle assembly 50 to enable the handle 52 to pivot relative to the longitudinal axis of the threaded rod 49, or generally to the clamp 14. The handle 52 is depicted in FIGS. 9-11 as comprising a rod or cylindrical body, but can take any desired form without departing from the scope of embodiments described herein. Surface features, such as knurling, ribs, protuberances, ridges, coating, or the like can be added to the surface of the handle 52 to aid gripping by a user or to enhance aesthetics.

A pair of clamp arms 15 are disposed on the exterior of the receiving tube 45 and the nested tube 46 in opposing orientations with one clamp arm 15 on each tube 45, 46. Each clamp arm 15 includes a curved portion 60 that is sized and formed to receive at least a portion of the clamp-engageable member 20 of the corresponding first or second adapter 12 or 13 in a substantially form-fitting manner. A pad 61, such as a section of rubber, foam, plastic, or similar material configured to reduce or prevent damage to the clamp-engageable member 20, may be provided on an inner surface of each curved portion 60 to prevent direct contact between the curved portion 60 and the clamp-engageable member 20. As depicted in FIGS. 9-11, the opposing orientations of the clamp arms 15 direct the inner surfaces of the curved portions 60 toward one another to capture the clamp-engageable members 20 of first and second adapters 12 and 13 therebetween as described more fully below. In another embodiment, the curved portions 60 may be directed away from one another to capture the clamp-engageable members 20 of first and second adapters 12 and 13 along respective inward surfaces thereof.

A guide 62 may be provided on the exterior of the clamp 14 to prevent rotational movement of the receiving tube 45 relative to the nested tube 46. The guide 62 includes an eye-flange 63 disposed on the exterior surface of the receiving tube 45 and a guide rod 64 coupled to the exterior surface of the nested tube 46. A bore or eye 65 extends through the eye-flange 63 and is longitudinally aligned with the receiving tube 45. The guide rod 64 comprises an elongate rod that is aligned parallel to the nested tube 46 and is spaced apart from the surface of the nested tube 46 a distance sufficient to allow the wall of the receiving tube 45 to pass between the guide rod 64 and the nested tube 46. The guide rod 64 is fixedly coupled at a first end to the nested tube 46 and extends toward and overlaps with the receiving tube 45 to slidably engage the eye 65. Engagement of the guide rod 64 with the eye-flange 63 thus allows longitudinal movement between the receiving tube 45 and the nested tube 46 while preventing relative rotation therebetween.

In operation, the clamp 14 is installed on the motorcycle by rotating the threaded rod 49 in a first direction, e.g. counterclockwise, to allow the clamp arms 15 to be moved away from one another a distance sufficient to receive the clamp-engageable members 20 of the first and second adapters 12 and 13 therebetween. The first and second adapters 12 and 13 are generally secured to frame members 17 and 18 of the motorcycle that extend along or near a bottom surface of the motorcycle in a generally longitudinal direction relative to the length of the motorcycle, such that the clamp-engageable members 20 are exposed for engagement by the clamp arms 15. The clamp 14 is disposed beneath and perpendicular to the length of the motorcycle and is brought upward to place the clamp arms 15 alongside the clamp-engageable members 20. The clamp arms 15 can then be moved toward one another to engage the clamp-engageable members 20 therebetween. The clamp arms 15 can be moved manually or by rotating the threaded rod 49 in an opposite second direction, e.g. clockwise. The threaded rod 49 is further rotated in the second direction to apply a force between the clamp arms 15 and the first and second adapters 12 and 13 mounted on the frame members 17 and 18 that is sufficient to retain the engagement under stresses applied during transport of the motorcycle. The handle 52 may be pivoted to enable greater mechanical advantage for rotating the threaded rod 49 and/or to prevent the handle 52 from obstructing rotation of the threaded rod 49, such as by contacting the ground or loading surface. A pin, lock, strap, or like device may be installed through the aligned bores 53, 54 formed in the first securement flange 51 and the second securement flange 55, respectively, to prevent inadvertent or intentional removal of the clamp 14 from the first and second adapters 12 and 13 by preventing the threaded rod 49 from being rotated in the first direction. Removal of the clamp 14 from the first and second adapters 12 and 13 is completed by rotating the handle 52 and threaded rod 49 in the first direction to allow the clamp arms 15 to move apart and free the clamp-engageable members 20.

The clamp 14 is configured to quickly and removably couple to the first and second adapters 12 and 13 such that the clamp 14 can be installed just prior to transportation of the motorcycle on the transport vehicle and removed after reaching the destination. The clamp 14 can be installed prior to or after loading/unloading the motorcycle onto the load bed of the transport vehicle. It is preferable to remove the clamp 14 from the first and second adapters 12 and 13 prior to driving the motorcycle so as to avoid interference of the clamp 14 with a rider and/or contact the clamp 14 with the ground or other obstacle.

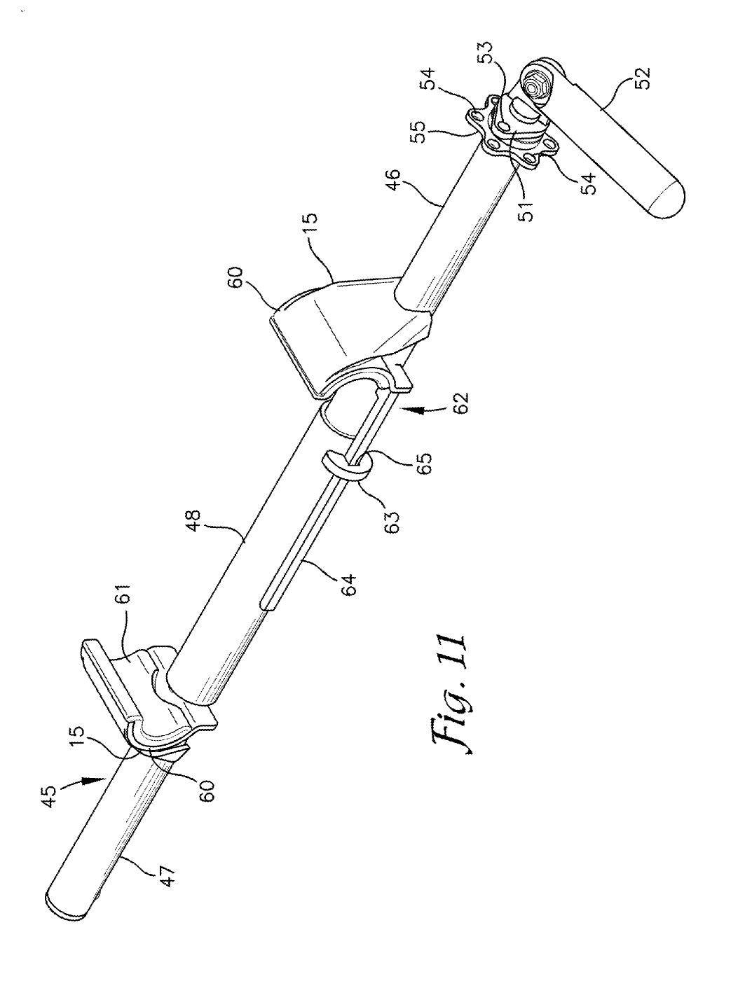

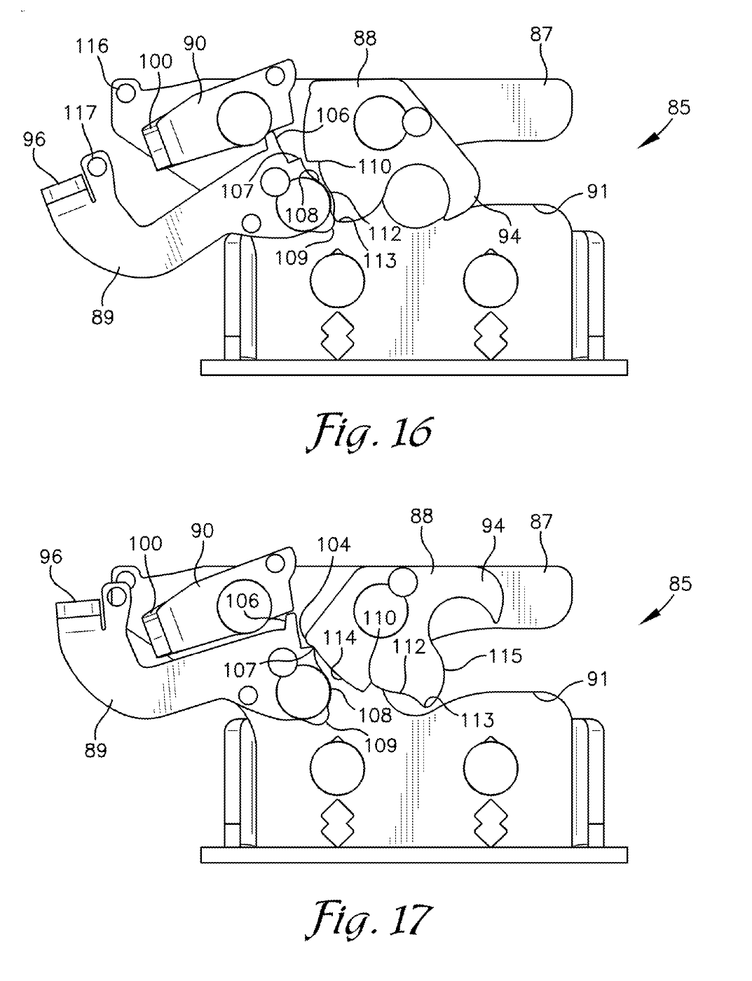

Referring now to FIGS. 12-18, the base 16 comprises an elongate base plate 80 with a mounting bracket 81 disposed near each end thereof. The base plate 80 includes a plurality of features, such as bores 82 which extend therethrough for fixedly mounting the base plate 80 to the loading surface of the transport vehicle, such as by bolts or other fasteners. The mounting brackets 81 stand upright on the base plate 80 and extend across the width thereof. A plurality of bores 83 are formed in the mounting brackets 81, and fasteners 84 are insertable through the bores 83 for coupling to a latch assembly 85 as described below. As best depicted in FIG. 16, a slot 86 may be provided in the base plate 80 alongside the mounting bracket 81 and sized to receive a lower extremity of a slot plate 87 of the latch assembly 85 to aid vertical adjustability of the latch assembly 85 relative to the base plate 80 as described below.

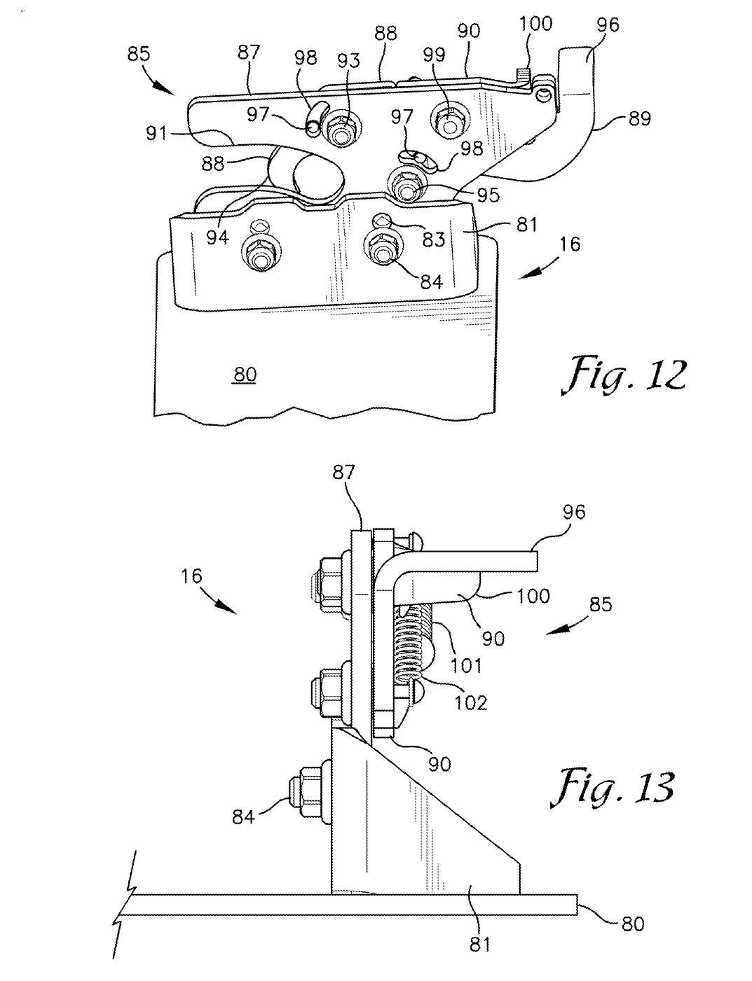

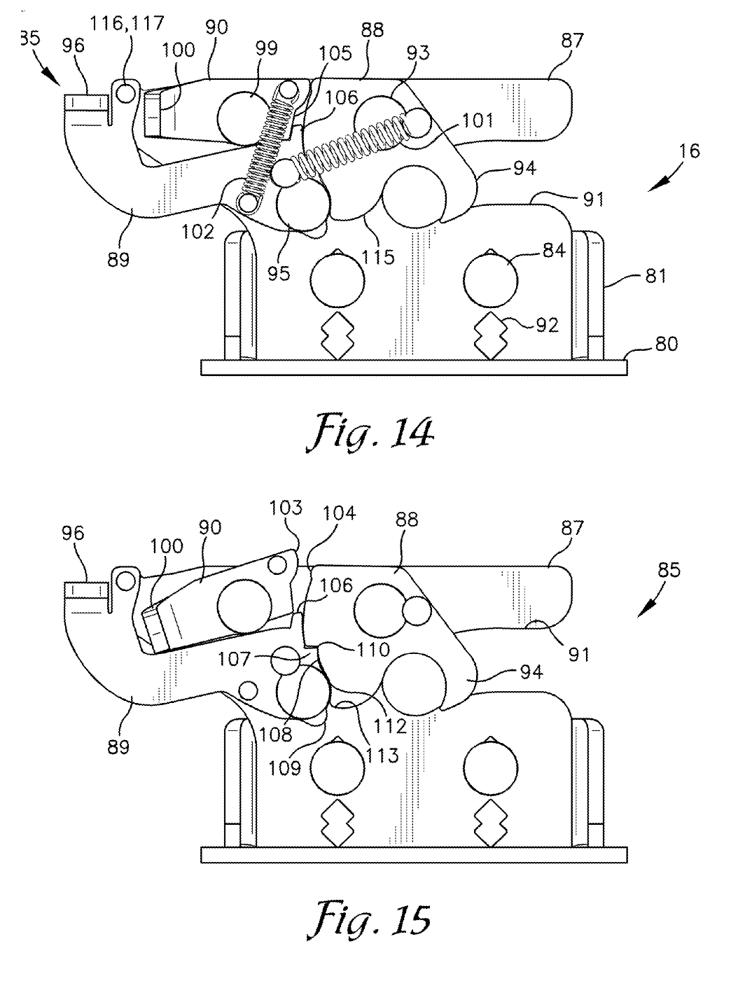

The latch assembly 85 is now described with reference to directional terms, including forward, rearward, clockwise, counter-clockwise, and the like, to describe the relative positions and movements of the components thereof. It should be understood that the directional terms used to describe the latch assembly 85 refer to the orientation shown in FIGS. 14-17, such that with respect to the drawings depicted in FIGS. 14-17 the words “front” or “forward” refer to the left-hand side, and the words “rearward” or “rear” refer to the right-hand side. Such is for simplicity in explanation and not to indicate a particular arrangement or orientation of the latch assembly 85 in use or operation.

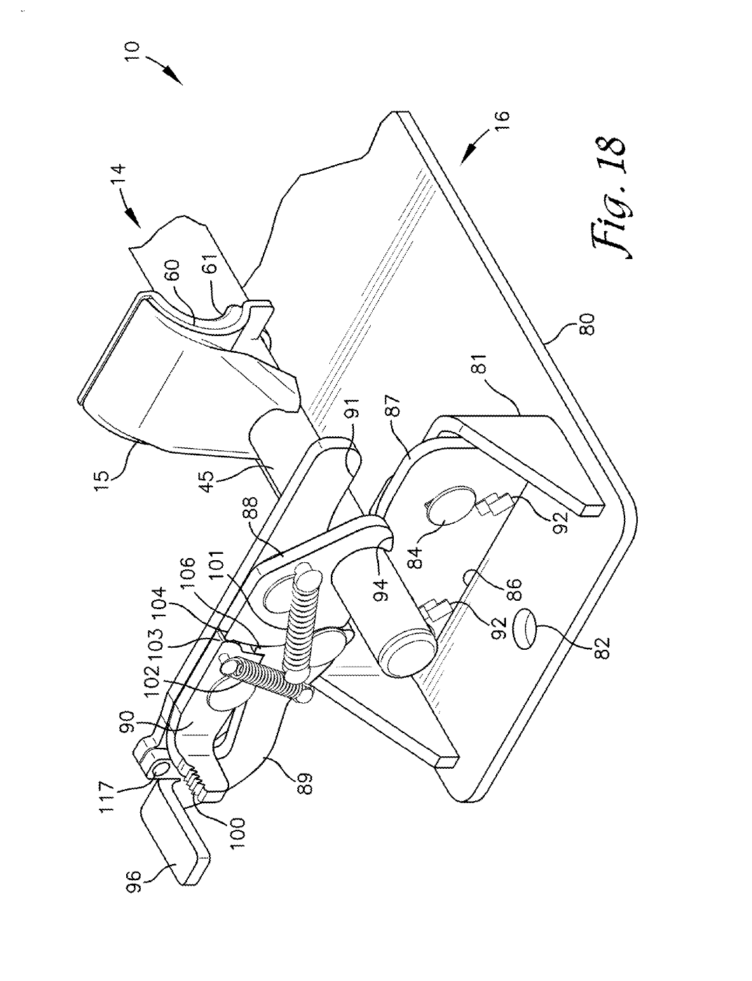

The latch assembly 85 comprises the slot plate 87, a latch plate 88, a release lever 89, and a locking lever 90. The slot plate 87 comprises a generally rectangular plate that forms the body of the latch assembly 85. A slot 91 extends forward into the body of the slot plate 87 from a rear edge thereof. As shown in FIG. 12, the slot 91 is generally horizontally oriented near the rear edge of the slot plate 87 but then turns or trails downward toward the base plate 80 as the slot 91 extends forward into the slot plate 87. The width of the slot 91 is larger than the outer diameter of the end portion 47 and the nested tube 46 of the clamp 14 to enable the clamp 14 to be received with the slot 91 as depicted in FIG. 18, e.g. with the clamp 14 oriented generally perpendicularly to the slot plate 87.

The slot plate 87 includes a plurality of mounting apertures 92 configured for alignment with selected ones of the bores 83 in the mounting brackets 81. The mounting apertures 92 may take any form or arrangement, but as depicted in FIG. 18, in one embodiment the mounting apertures 92 comprise pairs or multiples of overlapping polygon-shaped apertures, such as square- or diamond-shaped apertures arranged in a vertically stacked arrangement with adjacent corners of the polygons overlapping to form a continuous aperture. This arrangement enables a round- or square-shafted fastener 84 to be inserted through the mounting aperture 92 and to be at least partially vertically moveable within the mounting aperture 92. The fastener may include a shaft with dimensions smaller than those of the polygons forming the mounting aperture 92 to enable at least partial movement within the mounting aperture 92. Alternatively, the shaft may have dimensions corresponding with those of the polygons. Overlapping of the polygonal shapes provides positions for the fastener that are closer together than would be possible with separate apertures. For example, each polygon of the mounting aperture 92 may be sized and shaped to fixedly receive the shoulder of a fastener 84, such as a carriage bolt 84, while the round shaft of the carriage bolt 84 may have a diameter allowing the bolt 84 to be slid between mounting positions along the aperture 92 without complete removal of the bolt 84 from the aperture 92.

The latch plate 88, release lever 89, and locking lever 90 are each pivotably coupled to the slot plate 87 along a common side thereof. The latch plate 88 is pivotable about an axis formed by a fastener 93 coupling the latch plate 88 to the slot plate 87. Pivotal movement of the latch plate 88 moves an arm 94 extending from the latch plate 88 between an overlapping and non-overlapping relationship with the slot 91 in the slot plate 87. The latch plate 88 and the arm 94 form a generally arcuate surface configured to engage around the clamp 14 in a generally form-fitting manner when the clamp 14 is fully inserted into the slot 91. A generally circular opening is thus formed by the forward end of the slot 91 and the latch plate 88 in which the clamp 14 may be captured.

The release lever 89 is pivotable about an axis formed by a fastener 95 coupling the release lever 89 to the slot plate 87. The release lever 89 is a generally elongate member that extends forward away from the fastener 95 a distance before turning vertically upward and then outwardly away from the plane of the slot plate 87 to form a release pedal 96 that lies in a plane generally parallel to the base plate 80. As depicted in FIG. 12, the release lever 89 and the latch plate 88 may each include a respective pin 97, with the pins 97 extending into respective arcuate apertures 98 in the slot plate 87. The pins 97 and apertures 98 may define a range of pivotal motion of the release lever 89 and the latch plate 88.

The locking lever 90 lies vertically above the release lever 89 and is pivotable about an axis formed by a fastener 99. The locking lever 90 is a generally elongate member that extends rearward from the fastener 99 toward and into abutting contact with the latch plate 88. The locking lever 90 also extends forward from the fastener 99 a distance before turning outward and away from the plane of the slot plate 87 to form an unlocking pedal 100. A top surface of the unlocking pedal 100 may be positioned substantially vertically even with a top surface of the release pedal 96 and is spaced a distance rearward of the release pedal 96.

A first extension spring 101 is coupled between the latch plate 88 and the release lever 89. The spring 101 is coupled to the latch plate 88 at a location that provides an over-center condition that biases the latch plate 88 toward either an open position (shown in FIG. 17) or a closed position (shown in FIGS. 14-16). A second extension spring 102 is disposed between the release lever 89 and the locking lever 90 to bias the locking lever 90 toward clockwise rotation.

Interaction of the latch plate 88, release lever 89, and locking lever 90 is now described with reference to FIGS. 14-17, wherein FIG. 14 depicts a locked orientation of the latch assembly 85, FIG. 15 depicts an unlocked orientation, FIG. 16 depicts an unlatched orientation, and FIG. 17 depicts a released or armed orientation. The locking lever 90 is pivotable from a substantially horizontal position (shown in FIG. 14) to an angled position in which it is moved counter-clockwise about the fastener 99 to raise a rearward end thereof (shown in FIGS. 15-17). A rearward edge of the locking lever 90 includes an abutment 103 that, when in the horizontal position, aligns with and/or contacts a stop 104 protruding from a front edge of the latch plate 88. The locking lever 90 thereby resists counter-clockwise movement of the latch plate 88.

The rearward edge of the locking lever 90 also forms a recess 105 between the locking lever 90 and the forward edge of the locking lever 90 that is sized to accommodate a tooth 106 on the release lever 89. In the horizontal position, the locking lever 90 obstructs movement of the tooth 106 and thus the release lever 89 in the counter-clockwise direction. In the angled position, the bottom surface of the locking lever 90 is moved upward a distance just greater than the height of the tooth 106 to allow the tooth 106 to move beneath and along the bottom surface of the locking lever 90.

The release lever 89 is pivotable between several positions. In a first position shown in FIGS. 14 and 15, the release lever 89 obstructs pivotal movements of the latch plate 88 through abutting contact between a rearward edge of the release lever 89 and a forward edge of the latch plate 88. The rearward edge of the release lever 89 extends downward from the tooth 106 and turns sharply rearward to form a ridge 107 followed by a downwardly extending, curvilinear, sliding surface 108 before ending with a rearwardly extending bump 109.

Similarly, the forward edge of the latch plate 88 extends downwardly from the stop 104 and follows the contours of the release lever 89 to form a rearwardly receding recess 110 in which the ridge 107 is receivable and a second sliding surface 112 that abuts the sliding surface 108 before turning rearward just before reaching the bump 109 to form a point 113. Engagement of the ridge 107 on the release lever 89 with the recess 105 in the latch plate 88 prevents counter-clockwise rotation of the latch plate 88 and abutment of the sliding surfaces 108 and 112 prevents clockwise rotation of the latch plate 88.

Pivoting of the release lever 89 in the counter-clockwise direction (following movement of the locking lever 90 to the unlocked position) first withdraws the ridge 107 from the recess 105 in the latch plate 88, as depicted in FIG. 16. With the release lever 89 so pivoted, the latch plate 88 is able to rotate counter-clockwise when a rearwardly directed force is applied by the clamp 14 on the arm 94. Further rotation of the release lever 89 in the counter-clockwise direction brings the bump 109 into contact with the point 113 on the latch plate 88. The bump 109 may function as a cam surface along which the point 113 follows to cause the latch plate 88 to at least partially rotate in the counter-clockwise direction.

In one embodiment, such partial rotation is sufficient to overcome the over-center condition of the latch plate 88 and the extension spring 101, allowing the bias of the extension spring 101 to rotate the latch plate 88 to a position such as that depicted in FIG. 17. In another embodiment, the partial rotation is sufficient to move the latch plate 88 in the counter-clockwise direction a distance such that the ridge 107 of the release lever 89 is unable to re-engage the recess 105 when the release lever 89 is rotated in the reverse or clockwise direction by the extension spring 101. The ridge 107 thus comes into contact with an upper sliding surface 114 of the latch plate 88 and the latch plate 88 is placed in an unlatched orientation. The unlatched orientation may also be achieved by the clamp 14 transmitting a force provided by the compressed motorcycle suspension to the latch plate 88 that at least partially rotates latch plate 88 in the counter-clockwise direction.

In the unlatched orientation, the arm 94 of the latch plate 88 at least partially obstructs the slot 91 in the slot plate 87 and the ridge 107 of the release lever 89 slides along the upper sliding surface 114 of the latch plate 88 as the latch plate 88 is rotated in the counter-clockwise direction toward the released position depicted in FIG. 17. Upon full rotation of the latch plate 88 to the released orientation, the arm 94 is fully removed from the obstruction of the slot 91 and the ridge 107 of the release lever 89 contacts the stop 104 on the latch plate 88 to resist further counter-clockwise rotation of the latch plate 88. In the released orientation, the clamp 14 may be fully removed from the slot 91.

Although referred to as the released orientation, the orientation depicted in FIG. 17 may also be referred to as an armed orientation when describing engagement of the clamp 14 with the latch assembly 85. The latch plate 88 includes a cam 115 that is moved at least partially into the slot 91 when in the armed or released orientation. Engagement of the clamp 14 with the slot 91 and movement of the clamp 14 along the slot 91 toward the forward end of the slot 91 contacts the cam 115 and rotates the latch plate 88 in the clockwise direction to reverse the process described above and return the latch plate 88, release lever 89, and locking lever 90 to the locked orientation depicted in FIG. 14.

Operation of the motorcycle tie-down assembly 10 is now described in accordance with an embodiment of the invention. The base 16 is installed on the loading surface of the transport vehicle or trailer, and the clamp 14 is coupled to the clamp-engageable members or bars 20 of the first and second adapters 12 and 13 that are secured to the frame members 17 and 18 of the motorcycle as described previously above. Each of the latch assemblies 85 are placed in the armed positions as depicted in FIG. 17. The motorcycle is aligned perpendicular to the length of base plate 80 such that the motorcycle can be driven or manually walked or pushed across the base plate 80 between the mounting brackets 81 in a forward direction relative to FIGS. 14-17. The motorcycle is moved over the base plate 80 until the clamp 14 meets the slot plates 87 on each end of the base 16.

The clamp 14, and specifically the end portion 47 of the receiving tube 45 and the nested tube 46 thereof, are aligned with the slots 91 in a respective one of the slot plates 87. In one embodiment, a rider sits on the motorcycle to at least partially compress the suspension thereof and to thereby lower the clamp 14 for alignment with the slots 91. As discussed previously above, the slot plate 87 may be vertically adjusted during installation on the mounting brackets 81 using the mounting apertures 92 to relatively precisely align the slots 91 with the position of the clamp 14 when the rider is seated on the motorcycle.

Upon engagement of the clamp 14 with both slots 91, the motorcycle is moved further forward to translate the clamp 14 along the slots 91. Near the forward end of the slots, the clamp 14 is drawn vertically downward by the slots 91, thus further compressing the suspension of the motorcycle. Compression of the suspension of the motorcycle by the rider’s weight, and additionally by the downward sloping path of the slots 91, aids in providing a tight and secure coupling between the base 16 and the clamp 14, and between the clamp 14 and the first and second adapters 12 and 13 secured to the frame members 17 and 18 of the motorcycle. Movement of the clamp 14 forward along the slots 91 also engages the cam 115 on the latch plate 88 to move the latch assembly 85 from the armed orientation to the locked orientation as depicted in FIG. 18. The motorcycle is thus secured against movements and forces encountered during transportation.

The assembly 10 may be locked to prevent theft or removal of the motorcycle from the assembly 10. The slot plate 87 and the release lever 89 may include bores 116 and 117 that are aligned when the latch assembly 85 is in the locked orientation. A padlock, pin, rod, strap, or the like may be installed through the bores 116, 117 to prevent movement of the latch assembly 85 to the released orientation.

To disengage the clamp 14 from the base 16 and remove the motorcycle from the transport vehicle, a dual motion action is performed on the locking lever 90 and the release lever 89 of each latch assembly 85, such as by a foot of a rider. As depicted in FIG. 15, the unlocking pedal 100 of the locking lever 90 is first moved vertically downward below the height of the top surface of the release pedal 96 of the release lever 89. Once the tooth 106 of the release lever 89 is freed from the recess 105, the release pedal 96 is moved vertically downward a greater vertical distance than the unlocking pedal 100 to release the latch plate 88 and allow the clamp 14 to be withdrawn from the slot 91.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure is intended to demarcate those structures as including a plurality of possible arrangements or designs within the scope of the disclosure and readily identifiable by one of skill in the art to perform the particular function in a similar way without specifically listing all such arrangements or designs. Certain features and sub-combinations are of utility and may be employed without reference to other features and sub-combinations and are contemplated within the scope of the claims.

As used in the claims, identification of an element with an indefinite article “a” or “an” or the phrase “at least one” is intended to cover any device or assembly including one or more of the elements at issue. Similarly, references to first and second elements, or to a pair of elements, are not intended to limit the claims to such assemblies including only two of the elements, but rather are intended to cover two or more of the elements at issue. Only where limiting language such as “a single” or “only one” is used with reference to an element, is the language intended to be limited to one of the elements specified, or any other similar limited number of elements.

What is claimed is:

1. A tie-down assembly for transporting a vehicle having a pair of frame members extending along a length of the vehicle, the tie-down assembly comprising:
a pair of adapters, each of the adapters including:
a mounting structure securable to a corresponding one of the frame members, and a clamp-engageable member spaced apart from the mounting structure and exposed near a bottom surface of the vehicle;
a clamp adjustably engageable with each of the clamp-engageable members; and
a base securable to a transport vehicle, the base including a pair of latch assemblies disposed at opposite ends of the base, the latch assemblies spaced apart a distance sufficient to receive at least a portion of the vehicle therebetween, the latch assemblies configured to releasably capture the clamp to secure the vehicle to a transport vehicle.

2. The tie-down assembly as in claim 1, wherein the pair of adapters are opposingly oriented and each of the adapters extends outward of a corresponding one of the frame members.

3. The tie-down assembly as in claim 1, wherein each of the clamp-engageable members is a cylindrical bar.

4. The tie-down assembly as in claim 1, wherein each of the pair of adapters includes at least one mounting flange extending between the mounting structure and the clamp-engageable member of the respective adapter.

5. The tie-down assembly as in claim 1, wherein each of the adapters is oriented between a corresponding one of the frame members and a corresponding bracket for mounting a footrest.

6. The tie-down assembly as in claim 1, wherein each of the clamp-engageable members is oriented downward and forward of a corresponding one of the frame members.

7. The tie-down assembly as in claim 1, the clamp further comprising a pair of clamp members, each of the clamp members configured to matingly engage with a corresponding one of the clamp-engageable members.

8. The tie-down assembly as in claim 7, wherein each of the clamp members includes a curved inner surface and each of the clamp-engageable members includes a curved outer surface, each curved inner surface configured to abut against a corresponding one of the curved outer surfaces.

9. An adapter assembly for enabling a motorcycle to be secured to a transport vehicle, the adapter assembly comprising:
a first adapter comprising a first mounting bracket and a first clamp-engageable member, the first mounting bracket securable to a first frame member of the motorcycle; and
a second adapter spaced apart from and mirroring the first adapter, the second adapter comprising a second mounting bracket and a second clamp-engageable member, the second mounting bracket securable to a second frame member of the motorcycle;
wherein the first clamp-engagement member and the second clamp-engagement member are exposed for engagement with an adjustable clamp of a tie-down assembly.

10. The adapter assembly as in claim 9, wherein the first clamp-engageable member is oriented downward and forward of the first frame member, and the second clamp-engageable member is oriented downward and forward of the second frame member.

11. The adapter assembly as in claim 9, wherein the adjustable clamp includes a first clamp arm and a second clamp arm, the first clamp arm disposed outward of and matingly engageable with the first clamp-engagement member, and the second clamp arm disposed outward of and matingly engageable with the second clamp-engagement member.

12. The adapter assembly as in claim 11, wherein the first clamp arm and the second clamp arm include respective curved inner surfaces and the first clamp-engageable member and the second clamp-engageable member include respective curved outer surfaces, each curved inner surface configured to abut against a corresponding one of the curved outer surfaces.

13. The adapter assembly as in claim 9, wherein the first adapter extends between the first frame member of the motorcycle and a first bracket for mounting a first footrest, and the second adapter extends between the second frame member of the motorcycle and a second bracket for mounting a second footrest.

14. A tie-down assembly for securing a vehicle to a transport vehicle, the tie-down assembly comprising:
a first adapter and a second adapter spaced laterally apart from the first adapter, the first adapter and the second adapter mounted to a frame member of the vehicle, the first adapter including a first clamp-engageable member and the second adapter including a second clamp-engageable member, the first clamp-engageable member and the second clamp-engageable member extending away from the frame member and exposed to provide respective inner clamping surfaces;
an adjustable clamp including a first clamp arm and a second clamp arm spaced laterally apart from the first clamp arm, the first clamp arm and the second clamp arm extending away from the adjustable clamp and providing respective outer clamping surfaces, the first clamp arm oriented outward of the first clamp-engageable member, and the second clamp arm oriented outward of the second clamp-engageable member; and
a base securable to the transport vehicle, the base including at least one latch assembly;
wherein the first clamp arm is configured to engage the first clamp-engageable member and the second clamp arm is configured to engage the second clamp-engageable member to secure the clamp to the vehicle; and
the at least one latch assembly is configured to releasably capture the clamp to secure the vehicle to the transport vehicle.

15. The tie-down assembly as in claim 14, wherein the frame member is a first frame member and a second frame member, the first adapter mounted to the first frame member, and the second adapter mounted to the second frame member.

16. The tie-down assembly as in claim 14, wherein the first adapter extends between the frame member and a first footrest bracket, and the second adapter extends between the frame member and a second footrest bracket.

17. The tie-down assembly as in claim 14, the first adapter further comprising a first mounting bracket extending between the frame member and the first clamp-engageable member, and the second adapter further comprising a second mounting bracket extending between the frame member and the second clamp-engageable member.

18. The tie-down assembly as in claim 17, wherein the first mounting bracket and the first clamp-engageable member cooperate to form a first pocket extending therebetween, and the second mounting bracket and the second clamp-engageable member cooperate to form a second pocket extending therebetween, the first clamp arm extendable into the first pocket and the second clamp arm extendable into the second pocket.

19. The tie-down assembly as in claim 14, wherein the first clamp-engageable member and the second clamp-engageable member extend downwardly and forwardly away from the frame member.

20. The tie-down assembly as in claim 14, wherein the respective inner clamping surfaces of the first clamp-engageable member and the second clamp-engageable member are substantially convex, and the respective outer clamping surfaces of the first clamp arm and the second clamp arm are substantially concave.
